(19) United States
(12) Patent Application Publication
(10) Pub. No.: US 2008/0108336 A1
(43) Pub. Date: May 8, 2008

(54) Location-based services in wireless broadband networks

(76) Inventors: Muthaiah Venkatachalum, Beaverton, OR (US); Pouya Taaghol, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/648,178

(22) Filed: Dec. 29, 2006

Related U.S. Application Data
(60) Provisional application No. 60/858,163, filed on Nov. 8, 2006.

(51) Int. Cl. H04Q 7/22

(52) U.S. Cl. 455/414.3

(57) ABSTRACT

Embodiments of the invention relate to an end-to-end architecture for providing location-based content for mobile users in a broadband wireless access (BWA) network. In certain implementations, a mobile user may request content relevant to its location from a content provider such as an application service provider (ASP) in a public Internet. The ASP in turn signals a master location controller (MLC) in the BWA to find out the location of the mobile station. The MLC may contact a radio access network (RAN) node to initiate a mobile station location determination and provide the results back to the content provider. Additional embodiments and variations are also disclosed.

### CROSS-REFERENCE TO RELATED APPLICATIONS

This application claims priority under 35 U.S.C. §119e to co-pending U.S. application Ser. No. 60/858,163 entitled “END TO END ARCHITECTURE FOR LOCATION SERVICES IN WIRELESS BROADBAND NETWORKS” and filed by the instant inventors on Nov. 8, 2006.

### BACKGROUND OF THE INVENTION

There is ongoing interest in developing and deploying mobile networks which may facilitate transfer of information at broadband rates. These networks are colloquially referred to herein as broadband wireless access (BWA) networks and may include networks operating in conformance with one or more protocols specified by the 3^{rd} Generation Partnership Project (3GPP) and its derivatives or the Institute for Electrical and Electronic Engineers (IEEE) 802.16 standards (e.g., IEEE 802.16-2005), although the embodiments discussed herein are not necessarily so limited. IEEE 802.16 compliant BWA networks are sometimes referred to as WiMAX networks, an acronym that stands for Worldwide Interoperability for Microwave Access, which is a certification mark for products that pass conformity and interoperability tests for the IEEE 802.16 standards.

In modeling the deployment and implementation of WiMAX networks, there are ongoing questions on how to best integrate cooperation between service providers (SPs), which are the providers that operate network infrastructure and provide wireless access to subscribers, and Internet Application Service Providers (IASPs) (e.g., GOOGLE®, YAHOO®, etc.), which are providers that offer aggregated content on the public Internet Protocol (IP) networks including content providers (CPs) and/or Internet advertisers (IAs).

It is particularly challenging to provide content or other services to mobile users which require the location or proximity of a mobile user to be known; for example, in order to provide: search results which are relevant to a mobile user's location; mapping and directions for user unable to input a current location; and/or emergency services to a mobile user.

Currently there is no end-to-end (E2E) location-based service (LBS) architecture in WiMAX or related BWA networks. Additionally, there is no framework for application service providers to formally request the location of users in a WiMAX network to provide value add services based on the user's location. Accordingly, it would be desirable to have such capabilities.

### BRIEF DESCRIPTION OF THE DRAWING

Aspects, features and advantages of the present invention will become apparent from the following description of the invention in reference to the appended drawing in which like numerals denote like elements and in which:

FIG. 1 is functional block diagram of an end-to-end architecture according to various embodiments;

FIG. 2 is a signaling diagram for providing location-based services according to one aspect of the invention;

FIG. 3 is a signaling diagram for providing location-based services according to another aspect of the invention; and

FIG. 4 is a signaling diagram for providing location-based services according to yet another aspect of the invention.

### DETAILED DESCRIPTION OF THE INVENTION

While the following detailed description may describe example embodiments of the present invention in relation to networks utilizing orthogonal frequency division multiplexing (OFDM) or Orthogonal Frequency Division Multiple Access (OFDMA) modulation, the embodiments of present invention are not limited thereto and, for example, can be implemented using other multi-carrier or single carrier spread spectrum techniques such as direct sequence spread spectrum (DSSS), frequency hopping spread spectrum (FHSS), code division multiple access (CDMA) and others as well as hybrid combinations of such protocols. While example embodiments are described herein in relation to wireless metropolitan area networks (WMANs) such as WiMAX networks, the invention is not limited thereto and can be applied to other types of wireless networks where similar advantages may be obtained. Such networks specifically include, but are not limited to, wireless local area networks (WLANs) and/or wireless wide area networks (WWANs) such as cellular networks and the like.

There are many known techniques to detect the location of mobile users in a wireless network such as time difference of arrival (TDOA), angle of arrival (AOA), or global positioning system (GPS). While some or all of these techniques may be used in connection with the various embodiments of the invention, the focus of the LBS embodiments herein relate to a framework on how to manage and convey location information to successfully support E2E location services as well as collaborate between content providers and service providers.

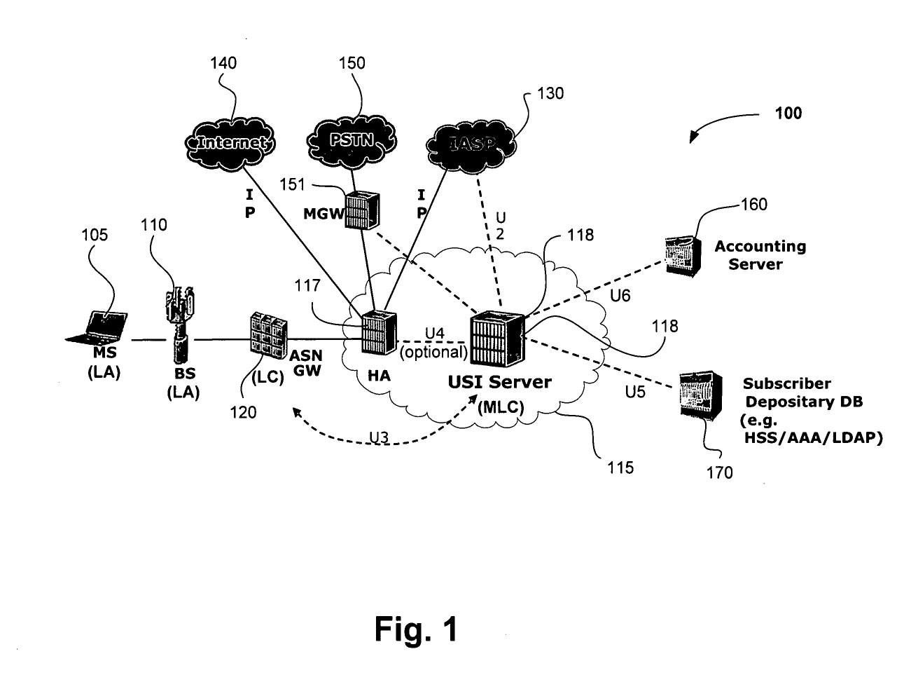

Turning to FIG. 1, an example network architecture 100 is shown for implementing E2E LBS according to various embodiments. According to one exemplary implementation, a mobile station (MS) 105, for example subscriber stations using protocols compatible with the IEEE 802.16 standards (e.g., IEEE 802.16-2005 Amendment), may communicate via an over-the-air (OTA) interface with a base station (BS) 110 to connect with a connectivity service network (CSN) 115 operated by a service provider.

Accordingly, in certain example implementations, communications between subscribers via BS 110 to CSN 115 may be facilitated via one or more location controllers (LCs) 120. In one implementation, location controllers 120 may be implemented as access service network gateways (ASN-GW) although the inventive embodiments are not limited to this specific type of network implementation. ASNGW 120 (or other similar type of RAN node) acts as an interface between core network 115 and a plurality of base stations 110 and may serve BS controller and/or mobile switching center (MSC) functions to facilitate handover and other functions for a radio access network (RAN), although the embodiments are not so limited.

Connectivity service network (CSN) 115, in certain example embodiments, may include a home agent (HA) 117 (or similar type of network node) and a master location controller (MLC) 118. In certain embodiments a new type of network node, referred to herein as a Universal Services Interface (USI) server may comprise MLC 118, which acts as a gateway for the interaction with Internet application service providers (IASP) 130 such as GOOGLE®, etc. Home agent 117 may serve as an Internet Protocol (IP) traffic hub to connect mobile users in network 100 (e.g., MS 105) with other non-service provider networks or entities such as a public Internet network 140, a public switched telephone network (PSTN) 150 and/or IASP 130. (In actuality, IASP 130 may be part of Internet network 140 but is shown separately in FIG. 1 to highlight various interactions with the service provider's CSN 115.)

If desired, a media gateway (MGW) node 151 may be used to convert circuit-switched communications to IP communications and/or vice versa between home agent 117 and PSTN 150 although the inventive embodiments are not limited in this respect.

According to certain embodiments, an accounting server 160 and/or subscriber depository database (DB) 170 may also be included in network 100.

Accounting server 160 may be coupled with, or be part of, the service provider's CSN 115 to account user subscription activities (e.g., to track user charges) while database 170 may be used to store customer profiles and/or personal data and preferences of subscribers (e.g., to identify users and authorized services). In certain embodiments sever 160 and database 170 may be combined in a single node. To this end, the description and illustration of network 100 represents logical entities and thus physical arrangements of certain entities could be combined with others or separated from one another according to network design preference and/or physical constraints.

According to the example network architecture in FIG. 1, the key logical interfaces for network 100 are as follows:

U2 interface: between the IASP 130 and master location controller 118;

U3 interface; between the serving location controller 120 and the master location controller 118; and

U4 interface; an optional interface between HA 117 and MLC 118. In certain embodiments, optional U4 interface may be used for quality-of-service (QoS) signaling between home agent 117 and MLC 118 for managed QoS services like IP television (IPTV). In other embodiments, U4 is omitted and the foregoing signaling may be conveyed directly to LC 120 via the U3 interface.

MLC 118 may also have interfaces U6 to accounting server 160 and U5 to subscriber depository DB 170 for content charging records and/or service authorization and user privilege.

According to certain inventive embodiments the U2 interface between IASP 130 and MLC 118 may be used primarily for user identification (e.g., user of mobile station 105) as well as any other interaction described herein between the service provider network and the IASP 130.

The U3 interface between MLC 118 and LC 120 is a signaling and hotlining interface which in certain embodiments may support functions for location services, presence, provisioning, etc.

The key functional for entities introduced in FIG. 1 include:

Master Location Controller (MLC) 118: may track the identification (ID) of a location controller (LC) 120 currently serving MS 105. MLC 118 forms part of connectivity services network (CSN 115) and may trigger location-based services (LBS) via interface U3 or in response to requests from IASP 130 (via interface U2) or MS 105. As previously mentioned, MLC 118 may reside in a USI server of the type disclosed in U.S. Appln. Ser. No. 60/858,194 entitled Universal Services Interface and filed by the instant inventors on Nov. 8, 2006 although the inventive embodiments are not limited in this respect.

Location Controller (LC) 115: is responsible for controlling the collection of location data for network initiated location requests as well as reporting of location data to the core network (e.g., CSN 115) and also optionally triggering the measurements. In one example implementation LC 115 may reside in an access service network gateway (ASN-GW) as mentioned above.

Location Agent (LA) 110: is responsible for the collection and reporting of data that may be required by a location measurement algorithm as well as optionally triggering location measurements and/or calculating the location. In certain embodiments, LA 110 may reside in a base station alone. In other embodiments, a location agent may reside in both MS 105 and BS 110. For example, if there is a LA in MS 120, then there is a corresponding LA in BS 125.

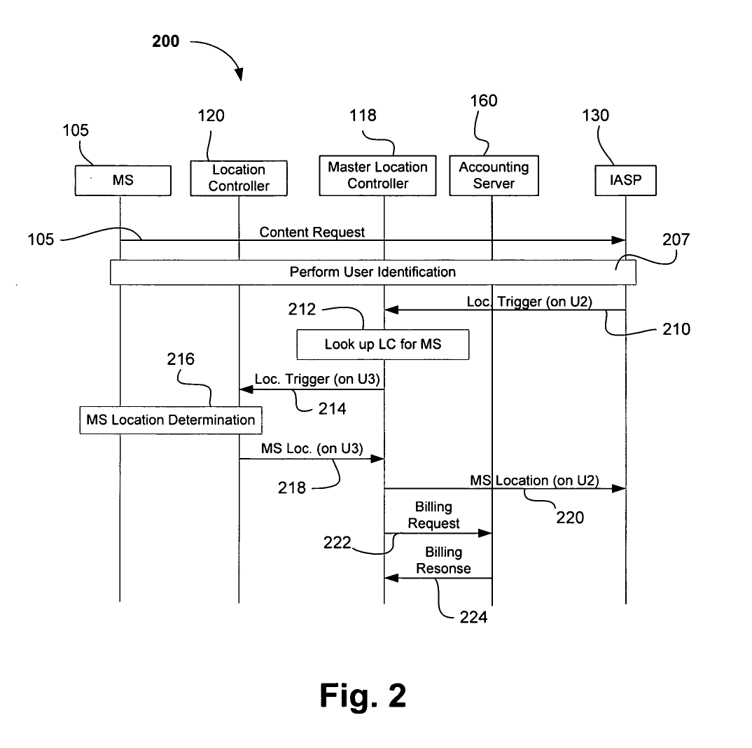

In the example wireless network 100 of FIG. 1, there are three main scenarios under consideration for mobile location measurement as shown in FIGS. 2-4.

Referring to FIG. 2, in a first scenario, a location measurement may be triggered by ASP 130 when MS 105 is in connected mode. This scenario could be used by content providers such as IASP 130 to get the location of the user in a WiMAX network and use this location to provide value add services like performing searches for local businesses, providing mapping and directions for a mobile user in the event the user is lost and/or does not know his current position, and/or other types of location-based services which may be offered by IASPs or emergency services providers. Thus a location determining process 200 for one embodiment may include mobile station 105 requesting 205 location-based service (LBS) content, such as driving directions from its present location, from Internet application service provider 130.

In response, IASP 130 may identify 207 the requesting mobile user and/or the service provider network (e.g., CSN 115; FIG. 1) through which the mobile user is connected. Identifying 207 the mobile user and/or user's service provider may be performed in a number of different manners. The user/MS 105 may be identified by IASP 130 via its IP address and/or the user IP address can be mapped to the service provider's MLC 118. For example, if IASP 130 knows a service provider's (SP's) IP subnet, once the user accesses the IASP content, IASP 130 may identify the user's SP from the user's IP subnet. Using a look up table, the master location controller 118 of that SP may be identified. In another example, a mobile user may be required to login for LBS content. In the process of login (or using cookies), the user's public network address identifier (NAI) becomes known to IASP. The realm part of the NAI may include information about the user's service provider which can be used to retrieve the IP address of MLC 118. Alternatively, a mobile user may identify itself and/or service provider through WebServices (e.g., JavaScript, CGI) or other proprietary interfaces.

Once the user and/or service provider's MLC 118 (e.g., USI server) is known to IASP 130, IASP 130 may contact 210 the appropriate MLC 118, via interface U2 (FIG. 1) to discover the present location of the mobile user 105. MLC 118 may in turn determine 212 which location controller (e.g., access service network gateway or other RAN node which may control MS handover/MS tracking) is currently serving MS 105 and signal 214 the appropriate location controller 120 to perform 216 a location determination for MS 105 (if it is not already known). Once determined by the location controller/agent, the location of MS 105 may then be signaled 218, 220 back to IASP 130 so that the requested LBS content may be provided (note: this LBS IP-traffic flow is not shown in FIG. 2).

In certain embodiments, if desired, the service provider operating MLC 118, may update subscriber charges or billings (which may include service fees for the SP and/or IASP) for the requested LBS service(s) with accounting server 160, e.g., via signaling 222 and 224.

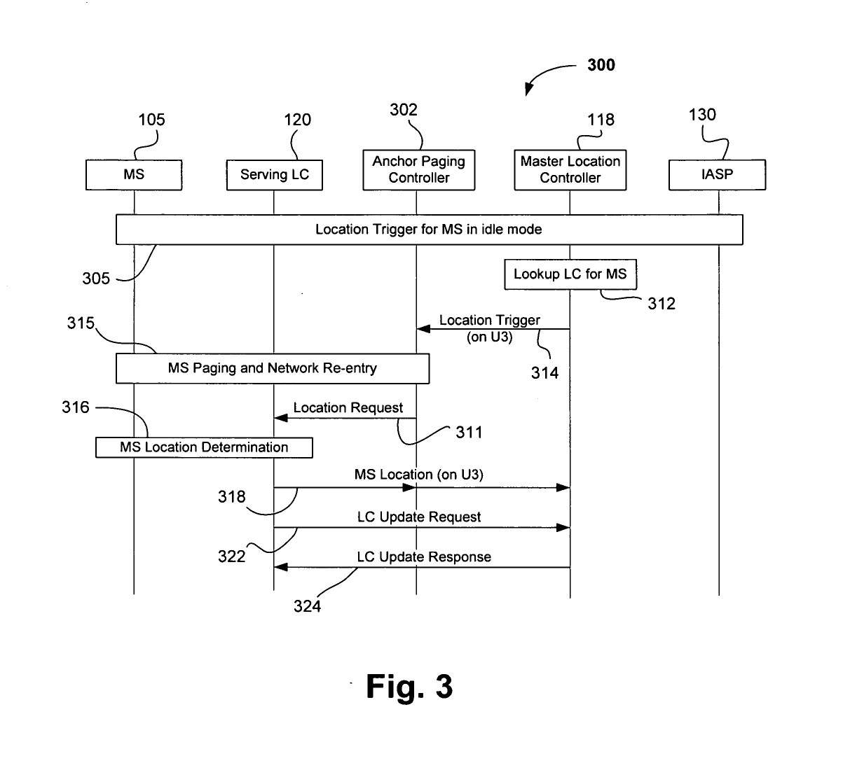

Referring to FIG. 3, another scenario including example signaling process 300 is shown for determining the location of MS 105 when it is in idle mode in a WiMAX network. In this case, a location trigger may be initiated 305 by one of the network entities. For example, when MS 105 enters idle mode and is assigned an anchor paging controller (APC) 302, the APC may update the master location controller 118. Alternatively, or in addition, other network entities such as a new location controller during mobile handoff may initiate 305 a location request, either of which causes MLC 118 to lookup 312 the location controller serving MS 105 and signal APC 302 to initiate 315 paging and network re-entry for MS 105. In turn, a location request may be sent 311 (from MLC 118 or APC 302) to serving location controller 120 to determine 316 the location of MS 105. Once determined 316, the location of MS 105 may be signaled 318 to APC 302 and/or MLC 118 or other network entity which may desire the location of MS 105.

Looking at process 300 in FIG. 3, it is evident that MLC 118 should be aware of the address of the currently serving location controller 120 (in this example an ASN-GW) of MS 105. This may be complicated by the fact that MS 105 may be in idle or connected modes. Accordingly, when MS 105 is in connected mode and it is handed over to a new ASN-GW via an inter ASN handover, the new target ASN-GW may send 322 a location update to MLC 118 and, if desired, MLC 118 may acknowledge the update by sending 324 a response. When MS 105 is in idle mode and is assigned an APC, APC may send and location control update to MLC 118. Thereafter, if MS 105 exits idle mode and is connected with a different ASN than the original APC's ASN, the local ASN-GW may send a location control update to MLC 118. If at any time, the APC changes, the new target APC may also update MLC 118 accordingly.

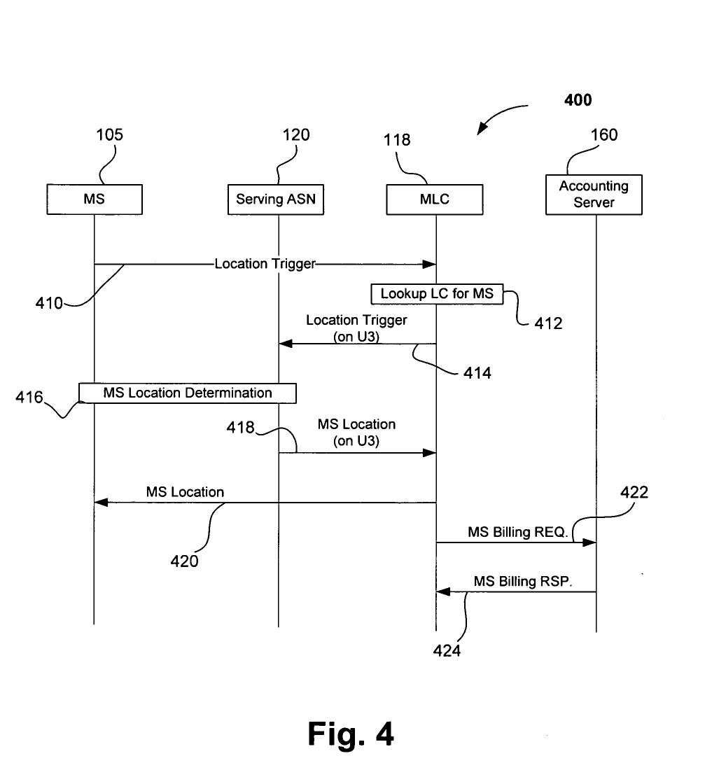

In another scenario, referring to FIG. 4, a process 400 for MS location determination may be triggered 410 by MS 105 itself. In these embodiments, MS 105 may be responsible for providing its location information directly to an IASP (not shown) for obtaining LBS content. Thus MS 105 may trigger 410 MLC 118 to lookup 412 and trigger 414 serving LC 120 and/or other node(s) to perform/initiate 416 an MS location determination in the radio access network. Once the MS location is determined 416, LC 120 may signal 418 the MS location to MLC 118 if desired. LC 120 or MLC 118 may then convey 420 the MS location back to MS 105. Similar to other embodiments, if desired, signaling 422, 424 may be exchanged with accounting server 160 to account charges for the location services provided by the service provider.

It should be recognized that the signaling examples and network entities described with reference to FIGS. 2-4 may vary significantly depending on the type of network utilized and preference of network designers. Accordingly, the foregoing signaling and entities are only presented as illustrative examples for potential implementation of the inventive embodiments. Furthermore, while embodiments have been described specifically for providing LBS content by Internet application service providers, the embodiments are not so limited and related signaling processes may be used to provide other entities, for example emergency service operators in PSTN 105 (FIG. 1), location information for MS 105.

Unless contrary to physical possibility, the inventors envision the embodiments described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method of communicating in a wireless network, the method comprising:
receiving a request for a mobile station's location from a requesting entity;
determining a location controller (LC) node which is serving the mobile station in a radio access network (RAN);
signaling the LC node to initiate a location determination for the mobile station;
receiving mobile station location information in response to the signaling; and
sending the mobile station location information to the requesting entity.

2. The method of claim 1 wherein the requesting entity comprises a location-based services (LBS) entity outside of the wireless network.

3. The method of claim 1 wherein the requesting entity comprises the mobile station.

4. The method of claim 2 wherein the LBS entity comprises one of an application service provider of a public Internet Protocol (IP) network or an emergency services operator of a public switched telephone network (PSTN).

5. The method of claim 1 wherein the LC node comprises an access service network gateway (ASN-GW) node.

6. The method of claim 1 further comprising:
signaling an accounting server to charge a subscriber associated with the mobile station for services associated with the location determination.

7. The method of claim 1 wherein the wireless network comprises a broadband wireless access (BWA) network.

8. The method of claim 7 wherein the broadband wireless access (BWA) network uses protocols compatible with the Institute of Electrical and Electronics Engineers (IEEE) 802.16-2005 standard.

9. The method of claim 1 further comprising:
receiving a location controller update from a target LC in association with a mobile handover of the mobile station.

10. The method of claim 1 further comprising receiving a location controller update from an anchor paging controller (APC) in response to the mobile station entering an idle mode.

11. A method of providing location-based services (LBS) content to mobile users in a broadband wireless access (BWA) network, the method comprising:
receiving a request for LBS content from a mobile station;
sending a mobile station location request to a service provider node of the BWA network;
receiving mobile station location information from the service provider node; and
providing the requested content to the mobile station.

12. The method of claim 11 wherein the requested content comprises hypertext transfer protocol (HTTP) content pertinent to a location of the mobile station.

13. The method of claim 11 wherein the broadband wireless access (BWA) network uses protocols compatible with the Institute of Electrical and Electronic Engineers (IEEE) 802.16-2005 standard.

14. A system for providing wireless communication, the system comprising:
a master location controller (MLC) node configured to communicate with one or more radio access network (RAN) nodes and a requesting entity, wherein in response to receiving a request from the requesting entity, the MLC node is further configured to trigger the one or more RAN nodes to determine a location of a mobile station, and wherein the MLC, in response to receiving the determined location, to signal the determined location to the requesting entity.

15. The system of claim 14 wherein the requesting entity comprises the mobile station.

16. The system of claim 14 wherein the requesting entity comprises one or more application service providers (ASPs) of a public Internet Protocol (IP) network.

17. The system of claim 14 wherein the requesting entity comprises one or more emergency service operators associated with a public switched telephone network (PSTN).

18. The system of claim 14 further comprising the one or more RAN nodes which form at least a portion of a broadband wireless access (BWA) network.

19. The system of claim 18 further comprising at least two types of RAN nodes including a first type comprising an access service network gateway (ASN-GW) node in communication with the MLC and a second type comprising a base station node coupled with the ASN-GW node to facilitate a radio link with the mobile station.

20. The system of claim 19 wherein the base station node uses modulation protocols compatible with an Institute of Electrical and Electronics Engineers (IEEE) 802.16-2005 standard.
